(19) United States
(12) Patent Application Publication
(10) Pub. No.: US 2006/0262268 A1
(43) Pub. Date: Nov. 23, 2006

(54) Eyeglass set with sunglass clip

(76) Inventor: Jong Kim, Los Angeles, CA (US)

Correspondence Address: PARK LAW FIRM, 3255 WILSHIRE BLVD, SUITE 1110, LOS ANGELES, CA, 90010, US

(21) Appl. No.: 11/133,890

(22) Filed: May 20, 2005

(51) Int. Cl. G02C 9/00

(52) U.S. Cl. 351/47

(57) ABSTRACT

A sunglass clipped eyeglass set comprising base lenses, a base bridge linking the base lenses and defined by top, bottom, inner and outer surfaces, cover lenses, and a cover bridge linking the cover lenses and having top and bottom plates whose outer portions are supported by at least one connector linking the plates so that a spatial channel is reserved by the plates and the connector. a protrusion is formed on each inner surface of the top and bottom plates to enable a clickable insertion of the base bridge into the spatial channel thereby, whereby the top and bottom plates are detachably carried over and on the corresponding top and bottom surfaces of the base bridge.

### BACKGROUND OF THE INVENTION

The present invention relates to an eyeglass system. More particularly, the present invention relates to a sunglass clipped eyeglass set enabling a cover bridge of the cover sunglasses to be detachably carried on a base bridge linking the base glasses in a clickable format.

Conventional eyeglasses with a sunglass clip show attachments around rims of the clip for its attachment to the base eyeglasses. Although such attachments provide convenience for dual usage without a separate sunglass set, the sunglass clip mechanism is known to have difficulty applying design concepts. Further, because the sunglass clip covering the base glasses is inevitably spaced apart from the base glasses, the user has to suffer dual reflection while using the sunglass clip, thus increasing fatigue of the user's eyes.

Another disadvantage of the conventional eyeglasses having a sunglass clip is that the sunglass clip is noticeable due to the attachments and the substantial gap between the base glasses and the cover glasses. One of the least welcome factors of the conventional eyeglasses having a sunglass clip would be difficulty applying fashion design to such eyeglass product, because of limitation caused by attachments and separate product from the base glasses.

A subsequent demand is to provide an eyeglass set with a sunglass clip that enables application of design concepts while maintaining convenience in attachments of the base and cover sets of an eyeglass system.

### SUMMARY OF THE INVENTION

The present invention is contrived to overcome the conventional disadvantages. Accordingly, an objective of the present invention is to provide a sunglass clipped eyeglass set that enables detachable sidewise clipping of a cover glass pair on a base glass pair utilizing bridges thereof. Another objective is to provide a sunglass clipped eyeglass set that maximizes adaptability of a cover glass set to rimless base eyeglasses. Further objective is to provide an eyeglass set that facilitates custom design while improving comfortability.

To achieve these and other objectives, the sunglass clipped eyeglass set according to the present invention comprises first and second base lenses, and a base bridge linking the base lenses and defined by top, bottom, inner and outer surfaces. Further comprised are first and second cover lenses, and a cover bridge linking the cover lenses, and having top and bottom plates whose outer portions are supported by at least one connector linking the plates so that a spatial channel is reserved by the plates and the connector. A protrusion is formed on each inner surface of the top and bottom plates to enable a clickable insertion of the base bridge into the spatial channel thereby, whereby the top and bottom plates are detachably carried over and on the corresponding top and bottom surfaces of the base bridge.

In a preferred embodiment, a boss is formed on the inner surface to face a user when the eyeglass set is worn with a bow pad partitioned to a bridge portion and wings extending from each end of the bridge portion. The bridge portion has an opening to receive the boss therein so that the bridge portion is attached to the inner surface of the base bridge. The bow pad is substantially elastic, and the top and bottom plates substantially cover the bridge portion of the bow pad.

The top and bottom plates of the cover bridge are aligned in a substantial horizontal mode to allow a sidewise attachment of the base bridge into the cover bridge. The cover bridge has an elongate opening to substantially expose the outer surface of the base bridge through the opening when the cover bridge is carried on the base bridge. The cover lenses are substantially colored where the substantially colored cover lenses are darker in color than the base lenses.

For a better performance, the cover lenses are substantially identical to the base lenses in lens surface curvature, and substantially covers the base bridge when the cover lenses supported by the cover bridge therebetween. Preferably, the cover lenses are formed of a polyamide material. The cover bridge is magnetized to the base bridge.

Advantages of the present invention are numerous in that: (1) the eyeglass set enables detachable sidewise clipping of the cover glass pair onto the base glass pair utilizing bridges thereof so as to allow the cover glass pair to become precisely inserted on the base glass pair when needed by a user, whereby the eyeglass set would look as regular sunglasses and maximizes the user's satisfaction; (2) the eyeglass system facilitates custom design for the base and cover lenses by adopting a highly flexible and chemical resistant polyamide material, thereby improving adaptability and satisfying user's fashion demand; and (3) elastic characteristics are applied to the bow pad especially between the cover bridges and the cover lenses, thereby improving product reliability and comfortability.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a sunglass clipped eyeglass set according to the present invention;

FIG. 2 is a cross-sectional view taken along line II-II in FIG. 1;

FIG. 3 is a cross-sectional view taken along line III-III in FIG. 1;

FIG. 4 is a perspective view showing construction of the present invention;

FIG. 5 is a cross-sectional view taken along line V-V in FIG. 4;

FIG. 6 is a perspective view showing attachment of a cover glass pair to a base glass pair;

FIG. 7 is a cross-sectional view taken along line VII-VII in FIG. 6; and

FIG. 8 is a front view of the eyeglass set according to the present invention.

### DETAILED DESCRIPTION OF THE PREFERRED EMBODIMENTS

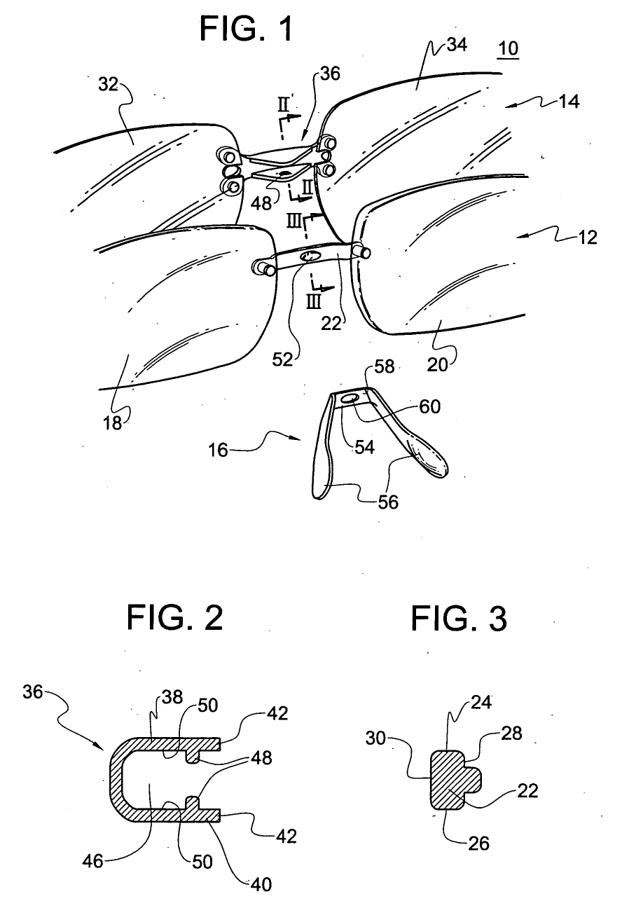

FIG. 1 shows a sunglass clipped eyeglass set 10 in an explosive view. As shown therein, the eyeglass set 10 includes a base glass pair 12, a cover glass pair 14, and a bow pad 16 attached to the cover glass pair 14. The cover glass pair 14 serves as sunglasses attachable to base glass pair 12.

In order for the eyeglass set 10 to a multi-purpose complete eyeglass system, the base glass pair 12 of the eyeglass set 10 includes first and second base lenses 18, 20. For the base lens connection, a base bridge 22 is provided to link the base lenses 18, 20 to each other. Here, the base bridge 22 is defined by top 24, bottom 26, inner 28 and outer 30 surfaces. The cover glass pair 14 serving as detachable sunglasses includes first and second cover lenses 32, 34.

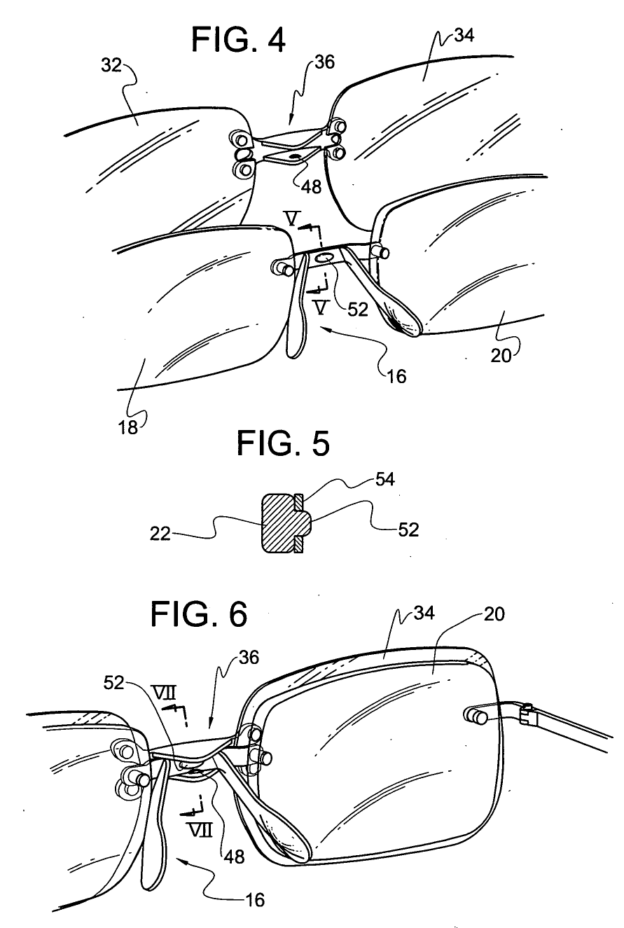

As further shown in FIGS. 2 through 8, for the cover lens connection, a cover bridge 36 is provided to link the cover lenses 32, 34. In this construction, the cover bridge 36 includes top and bottom plates 38, 40 whose outer portions 42 facing toward a user's face when the eyeglass set 10 is worn by the user are supported by at least one connector 44 linking the top and bottom plates 38, 40 so that a spatial channel 46 is reserved by the plates 38, 40 and the connector 44.

For a better performance, a protrusion 48 is formed on each inner surface 50 of the top and bottom plates 38, 40 to enable a clickable insertion of the base bridge 22 into the spatial channel 46 thereby, whereby the top and bottom plates 38, 40 are detachably carried over and on the corresponding top and bottom surfaces 24, 26 of the base bridge 22.

To facilitate a reliable attachment of the bow pad 16 to the cover bridge 36, a boss 52 is formed on the inner surface 28 which is to face a user when the eyeglass set is worn by the user. It is recommended that the bow pad 16 is substantially elastic to improve comfortability of the user. The bow pad is preferably partitioned to a bridge portion 54 and wings 56 extending from each end 58 of the bridge portion 54. To communicate with the boss 52 of the base bridge 22, the bridge portion 54 has an opening 60 to receive the boss 52 therein so that the bridge portion 54 is attached to the inner surface 28 of the base bridge 22. In this construction, the bow pad 16 is fixed to the base bridge 22 so as for the boss 52 to penetrate through the opening 60 in the bow pad 16.

To further differentiate the eyeglass set 10, the top and bottom plates 38, 40 of the cover bridge 36 are aligned in a substantial horizontal mode to allow a sidewise attachment of the base bridge 22 into the cover bridge 36. Specifically, the top and bottom plate 38, 40 of the cover bridge 36 are substantially horizontal when the eyeglass set 10 is worn by the user.

In an embodiment, the cover bridge 36 has an elongate opening 62 to substantially expose the outer surface 30 of the base bridge 22 through the opening 62 when the cover bridge 36 is carried or clipped on the base bridge 22.

When assembled to get worn by the user, the cover bridge 36 substantially covers the base bridge 22 when the cover lenses 32, 34 supported by the cover bridge 36 therebetween are carried over and on the base lenses 18, 20 so as to improve stability in the detachable attachment of the base and cover glass pairs 12, 14. In order to further improve stability in the detachable attachment characteristic, the cover bridge 36 may be magnetized to the base bridge 22.

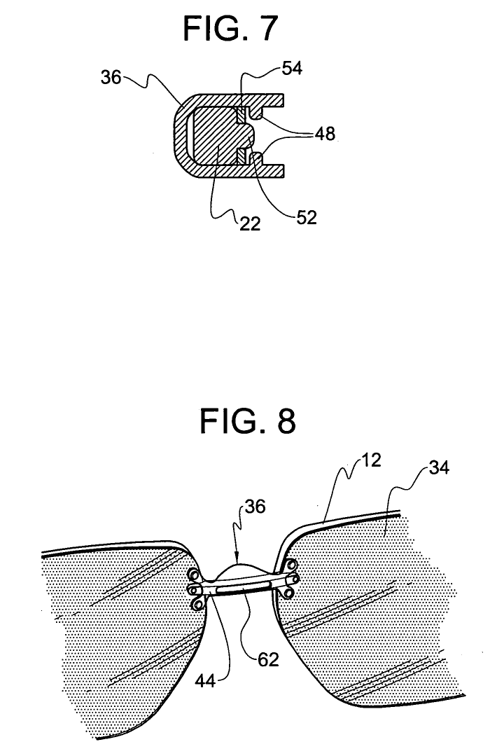

As further shown in FIG. 7 demonstrating the cross-section of FIG. 6, the top and bottom plates 38, 40 substantially cover the bridge portion 54 of the bow pad 16. In addition, the protrusion 48 extending from each inner surface 50 of the cover bridge 36 controllably covers the bridge portion 54 of the bow pad 16 to improve stability in the attachment of the cover bridge 36 to the base bridge 22.

Meanwhile, the cover lenses 32, 34 are substantially colored. Preferably, the substantially colored cover lenses 32, 34 are darker in color than the base lenses 18, 20. In a preferred mode, the cover lenses 32, 34 are substantially identical to the base lenses 18, 20 in lens surface curvature. The cover lenses 32, 34 are prefrably formed of a polyamide material which reserves highly flexibly and light weight characteristics. Preferably, the cover lenses 32, 34 are formed of a micro-crystalline polyamide (MCP).

As discussed above, an advantage of the sunglass clipped eyeglass set 10 is the characteristic enabling detachable sidewise clipping of the cover glass pair 14 onto the base glass pair 12 utilizing bridges 22, 36 thereof so as to allow the cover glass pair 14 to become precisely inserted on the base glass pair 12 when needed by a user, whereby the eyeglass set would look as regular sunglasses and maximizes the user's satisfaction.

In addition, elastic characteristics and boss-applied attachment mechanism between the bow pad 16 and the base bridge 22 improves stability while maintaining beauty factors obtained by custom design, thereby improving product reliability and comfortability. Further, the eyeglass set 10 facilitates custom design for the base and cover lenses by adopting a highly flexible and chemical resistant polyamide material, thereby improving adaptability and satisfying user's fashion demand.

Although the invention has been described in considerable detail with reference to certain preferred versions thereof, other versions are possible by converting the aforementioned construction. Therefore, the scope of the invention shall not be limited by the specification specified above and the appended claims.

1. A sunglass clipped eyeglass set, comprising:
a) first and second base lenses;
b) a base bridge linking the base lenses and defined by top, bottom, inner and outer surfaces;
c) first and second cover lenses; and
d) a cover bridge linking the cover lenses, and having top and bottom plates whose outer portions facing toward a user's face when the eyeglass set is worn by the user are supported by at least one connector linking the plates so that a spatial channel is reserved by the plates and the connector, wherein a protrusion is formed on each inner surface of the top and bottom plates to enable a clickable insertion of the base bridge into the spatial channel thereby, whereby the top and bottom plates are detachably carried over and on the corresponding top and bottom surfaces of the base bridge
wherein the top and bottom plates of the cover bridge are tapered from the connector.

2. The eyeglass set of claim 1 wherein the top and bottom plates of the cover bridge are aligned in a substantial horizontal mode to allow a sidewise attachment of the base bridge into the cover bridge.

3. The eyeglass set of claims 1 wherein the cover bridge has an elongate opening to substantially expose the outer surface of the base bridge through the elongate opening when the cover bridge is carried on the base bridge.

4. The eyeglass set of claims 1 wherein the cover lenses are substantially colored, wherein the substantially colored cover lenses are darker in color than the base lenses.

5. The eyeglass set of claim 1 wherein the cover lenses are substantially identical to the base lenses in lens surface curvature.

6. The eyeglass set of claim 1 wherein the cover bridge substantially covers the base bridge when assembled for eyeglass use.

7. The eyeglass set of claim 1 wherein the cover lenses are formed of a polyamide material.

8. The eyeglass set of claim 1 wherein the cover bridge is magnetically attached to the base bridge.

9. A sunglass clipped eyeglass set, comprising:
a) first and second base lenses;
b) a base bridge linking the base lenses and defined by top, bottom, inner and outer surfaces, wherein a boss is formed on the inner surface to face a user when the eyeglass set is worn;
c) a bow pad partitioned to a bridge portion and wings extending from each end of the bridge portion, wherein the bridge portion has a pad opening to receive the boss therein so that the bridge portion is attached to the inner surface of the base bridge;
d) first and second cover lenses; and
e) a cover bridge linking the cover lenses, and having top and bottom plates whose outer portions facing toward a user's face when the eyeglass set is worn by the user are supported by at least one connector linking the plates so that a spatial channel is reserved by the plates and the connector, wherein a protrusion is formed on each inner surface of the top and bottom plates to enable a clickable insertion of the base bridge into the spatial channel thereby, whereby the top and bottom plates are detachably carried over and on the corresponding top and bottom surfaces of the base bridge;
wherein the top and bottom plates of the cover bridge are tapered from the connector.

10. The eyeglass set of claim 9 wherein the top and bottom plates of the cover bridge are aligned in a substantial horizontal mode to allow a sidewise attachment of the base bridge into the cover bridge.

11. The eyeglass set of claims 9 wherein the cover bridge has an elongate opening to substantiall expose the outer surface of the base bridge through the elongate opening when the cover bridge is carried on the base bridge.

12. The eyeglass set of claims 9 wherein the cover lenses are substantially colored, wherein the substantially colored cover lenses are darker in color than the base lenses.

13. The eyeglass set of claim 9 wherein the cover lenses are substantially identical to the base lenses in lens surface curvature.

14. The eyeglass set of claim 9 wherein the cover bridge substantially covers the base bridge when assembled for eyeglass use.

15. The eyeglass set of claim 9 wherein the cover lenses are formed of a polyamide material.

16. The eyeglass set of claim 9 wherein the cover bridge is magnetically attached to the base bridge.

17. The eyeglass set of claim 9 wherein the bow pad is substantially elastic.

18. The eyeglass set of claim 9 wherein the top and bottom plates substantially cover the bridge portion of the bow pad.

19. The eyeglass set of claim 1 wherein the top and bottom plates have a substantially triangular shape.

20. The eyeglass set of claim 9 wherein the top and bottom plates have a substantially triangular shape.
